(19) United States
(12) Patent Application Publication
(10) Pub. No.: US 2026/0013019 A1
(43) Pub. Date: Jan. 8, 2026

(54) LIGHT EMITTING DEVICE, EXPOSING DEVICE, AND IMAGE FORMING APPARATUS

(71) Applicant: FUJIFILM Business Innovation Corp., Tokyo (JP)

(72) Inventors: Masato YAMAZOE, Kanagawa (JP); Takashi Fujimoto, Kanagawa (JP); Michihiro Inoue, Kanagawa (JP)

(73) Assignee: FUJIFILM Business Innovation Corp., Tokyo (JP)

(21) Appl. No.: 19/039,086

(22) Filed: Jan. 28, 2025

(30) Foreign Application Priority Data
Jul. 4, 2024 (JP) 2024-108362

(51) Int. Cl. H05B 47/155; G03G 15/043; H05B 33/06; H05B 45/34

(52) U.S. Cl. CPC H05B 47/155; G03G 15/043; H05B 33/06; H05B 45/34

(57) ABSTRACT

A light emitting device includes: plural light emitting elements including anode terminals to which a reference potential is applied, and cathode terminals connected to a first end of a current limiting resistor in common; a turn-on instructor configured to sequentially output turn-on instruction signals to the plural light emitting elements to sequentially turn ON the plural light emitting elements; a turn-on potential applier configured to apply a turn-on potential to a second end of the current limiting resistor; a turn-off instructor configured to, when turning OFF a light emitting element in an ON state, output a turn-off signal while changing the turn-off signal from a high level to a low level; a level shift circuit configured to change a low-level voltage of the turn-off signal according to the turn-on potential; and at least one turn-off thyristor including an anode terminal to which the reference potential is applied, a gate terminal connected to the first end of the current limiting resistor, and a cathode terminal to which the turn-off signal having the low-level voltage changed by the level shift circuit is input, the at least one turn-off thyristor being configured to be switched from OFF to ON when the turn-off signal reaches the low level, and change potentials at the cathode terminals of the plural light emitting elements to potentials at which the plural light emitting elements are turned OFF.

### CROSS-REFERENCE TO RELATED APPLICATIONS

This application is based on and claims priority under 35 USC 119 from Japanese Patent Application No. 2024-108362 filed Jul. 4, 2024.

### BACKGROUND

### (i) Technical Field

The present disclosure relates to a light emitting device, an exposing device, and an image forming apparatus.

### (ii) Related Art

Japanese Unexamined Patent Application Publication No. 2013-149795 discloses a light emitting chip, a print head, and an image forming apparatus in which an auxiliary gate is provided to reduce a driving voltage of a turn-off element that turns OFF a light emitting element.

Japanese Unexamined Patent Application Publication No. 2013-199039 discloses a light emitting chip, a print head, and an image forming apparatus in which a driving thyristor is provided to reduce a current of a turn-off signal when a turn-off element is operated to turn OFF a light emitting element that is emitting light.

Japanese Unexamined Patent Application Publication No. 2015-074178 discloses a light emitting component, a print head, and an image forming apparatus in which transfer failure of a transfer thyristor is suppressed.

### SUMMARY

An electrophotographic image forming apparatus such as a printer, a copying machine, or a facsimile machine uses a recording device including, as an exposing device, an LED print head (LPH) including a light emitting element array in which a plurality of light emitting elements such as light emitting diodes (LEDs) is arrayed in a main scanning direction. A light emitting chip including a self-scanning light emitting device (SLED) in which a plurality of light emitting elements is arrayed on a substrate and controlled to be sequentially turned ON uses light emitting thyristors as the light emitting elements.

In a control circuit that causes the plurality of light emitting thyristors to sequentially emit light, a turn-on instruction signal is output to the light emitting thyristor to turn ON the light emitting thyristor, and then a turn-off thyristor is turned ON by a turn-off signal to turn OFF the light emitting thyristor in the ON state. When a reference potential or a turn-on potential is changed to adjust the light exposure amount through a change in the light intensity of the light emitting thyristor that emits light, however, there is a possibility of a turn-off failure state of the light emitting thyristor in which the turn-off thyristor is not turned ON and the light emitting thyristor is not turned OFF, or an erroneous turn-on state of the turn-off thyristor in which the turn-off thyristor is erroneously turned ON in an unwanted period.

Aspects of non-limiting embodiments of the present disclosure therefore relate to a light emitting device, an exposing device, and an image forming apparatus in which the variable ranges of the reference potential and the turn-on potential may be increased without causing the turn-off failure state of the light emitting thyristor and the erroneous turn-on state of the turn-off thyristor compared with a case where the voltage of the turn-off signal is fixed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a light emitting device comprising: a plurality of light emitting elements including anode terminals to which a reference potential is applied, and cathode terminals connected to a first end of a current limiting resistor in common; a turn-on instructor configured to sequentially output turn-on instruction signals to the plurality of light emitting elements to sequentially turn ON the plurality of light emitting elements; a turn-on potential applier configured to apply a turn-on potential to a second end of the current limiting resistor; a turn-off instructor configured to, when turning OFF a light emitting element in an ON state, output a turn-off signal while changing the turn-off signal from a high level to a low level; a level shift circuit configured to change a low-level voltage of the turn-off signal according to the turn-on potential; and at least one turn-off thyristor including an anode terminal to which the reference potential is applied, a gate terminal connected to the first end of the current limiting resistor, and a cathode terminal to which the turn-off signal having the low-level voltage changed by the level shift circuit is input, the at least one turn-off thyristor being configured to be switched from OFF to ON when the turn-off signal reaches the low level, and change potentials at the cathode terminals of the plurality of light emitting elements to potentials at which the plurality of light emitting elements is turned OFF.

### BRIEF DESCRIPTION OF THE DRAWINGS

An exemplary embodiment of the present disclosure will be described in detail based on the following figures, wherein:

FIG. 1 illustrates the configuration of an image forming apparatus of an exemplary embodiment of the present disclosure;

FIG. 2 illustrates the configuration of a print head illustrated in FIG. 1;

FIG. 3 illustrates the configuration of a light emitting device illustrated in FIG. 2;

FIG. 4 illustrates the circuit configuration of a light emitting chip;

FIG. 5 illustrates an equivalent circuit of a thyristor;

FIGS. 6A and 6B illustrate operations of the equivalent circuit of the thyristor illustrated in FIG. 5;

FIG. 7 illustrates a state in which a light emitting thyristor is turned ON and lit by a turn-on instruction signal from a turn-on instructor;

FIG. 8 illustrates a state in which a turn-off signal is changed to a low-level voltage (0 V);

FIG. 9 illustrates a state in which a voltage at a gate terminal increases and the light emitting thyristor is turned OFF;

FIG. 10 is a timing chart illustrating voltage changes in the operations of the light emitting chip illustrated in FIGS. 7 to 9;

FIG. 11 illustrates a condition under which erroneous turn-on failure of a turn-off thyristor occurs;

FIG. 12 illustrates a condition under which the turn-off thyristor is securely turned ON and turn-off failure of the light emitting thyristor does not occur;

FIG. 13 illustrates a normal operation range in which neither the turn-off failure nor the erroneous turn-on failure occurs when a reference potential is fixed to 4.5 V and a voltage of a turn-on potential is variable;

FIG. 14 illustrates a normal operation range in which neither the turn-off failure nor the erroneous turn-on failure occurs when the turn-on potential is fixed to 0 V and the voltage of the reference potential is variable;

FIG. 15 illustrates the configuration of a driving control circuit of the light emitting device of the exemplary embodiment of the present disclosure;

FIG. 16 illustrates a variable range of the voltage of the turn-on potential when the VRLo voltage is adjusted according to the voltage of the turn-on potential;

FIG. 17 illustrates an example of a specific circuit configuration of a level shift circuit illustrated in FIG. 15;

FIG. 18 illustrates an example of a specific circuit configuration of a VRLo voltage controller illustrated in FIG. 15;

FIG. 19 illustrates an example of setting of the VRLo voltage relative to a V3 voltage;

FIG. 20 illustrates the circuit configuration of a level shift circuit as a modification of the level shift circuit illustrated in FIG. 17; and

FIG. 21 illustrates a variable range of the voltage of the reference potential when an undershoot circuit is used.

### DETAILED DESCRIPTION

An exemplary embodiment of the present disclosure is described in detail with reference to the drawings.

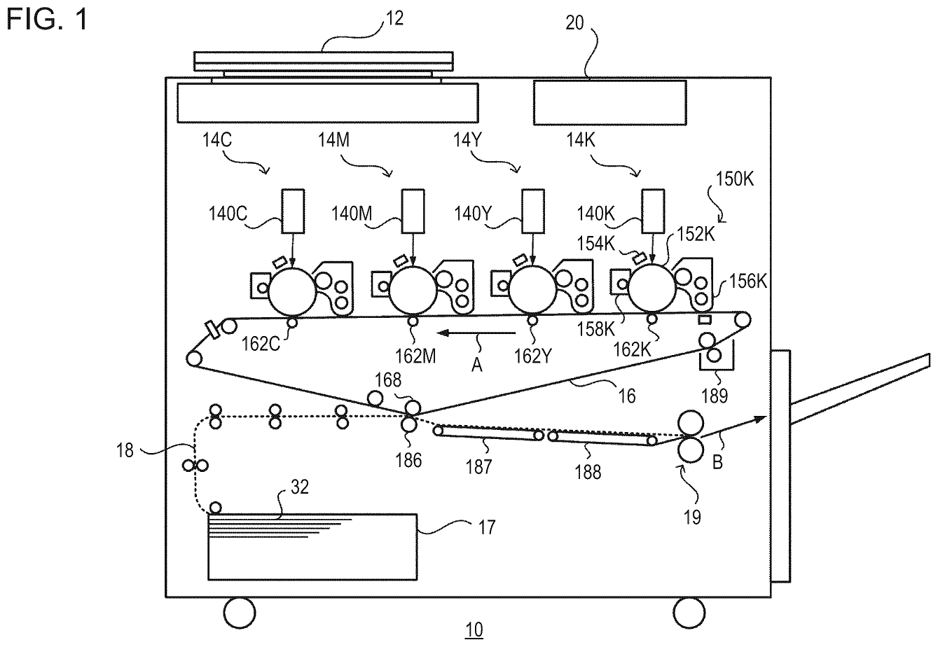

FIG. 1 illustrates the configuration of an image forming apparatus 10 of the exemplary embodiment of the present disclosure.

As illustrated in FIG. 1, the image forming apparatus 10 includes an image reading device 12, image forming units 14, an intermediate transfer belt 16, a paper tray 17, a sheet transport path 18, a fixing device 19, and a controller 20. The image forming apparatus 10 is a multifunction peripheral having a function of a printer that prints image data received from a personal computer (not illustrated) etc., a function of a full-color copying machine using the image reading device 12, and a function of a facsimile machine.

An overview of the image forming apparatus 10 is described. The image reading device 12 and the controller 20 are disposed at an upper part of the image forming apparatus 10. The image reading device 12 reads a document image and outputs the document image to the controller 20. The controller 20 performs image processing such as gray-level correction and resolution correction on image data input from the image reading device 12 or image data input from a personal computer (not illustrated) etc. via a network such as a LAN, and controls operations of the image forming units 14 to generate an image based on the image data.

Four image forming units 14 are disposed below the image reading device 12 in conjunction with colors of color images. In this exemplary embodiment, four image forming units 14K, 14Y, 14M, and 14C are horizontally arrayed with predetermined intervals along the intermediate transfer belt 16 in conjunction with black (K), yellow (Y), magenta (M), and cyan (C), respectively. The intermediate transfer belt 16 rotates in a direction of an arrow A in FIG. 1 as an intermediate transfer body. The four image forming units 14K, 14Y, 14M, and 14C sequentially form color toner images based on image data input from the controller 20. The plurality of toner images is transferred onto the intermediate transfer belt 16 (first transfer) at timings at which they are laid one on top of another. The order of colors of the image forming units 14K, 14Y, 14M, and 14C is not limited to “black (K), yellow (Y), magenta (M), cyan (C)” and may be any order such as “yellow (Y), magenta (M), cyan (C), black (K).”

The sheet transport path 18 is disposed below the intermediate transfer belt 16. Recording paper 32 fed from the paper tray 17 is transported along the sheet transport path 18. The color toner images transferred onto the intermediate transfer belt 16 in multiple layers are collectively transferred onto the recording paper 32 (second transfer). The transferred toner images are fixed by the fixing device 19 and the recording paper 32 is output to the outside along an arrow B.

Each component of the image forming apparatus 10 is described in more detail.

The image forming units 14K, 14Y, 14M, and 14C (image formers) are disposed parallel to each other with predetermined intervals in the horizontal direction, and have substantially the same configurations except that the colors of images to be formed are different. The image forming unit 14K is described hereinafter. The components of the image forming units 14 are distinguished by a suffix K, Y, M, or C.

The image forming unit 14K includes a print head 140K that forms an electrostatic latent image by performing a light exposure process based on image data input from the controller 20, and an image forming device 150K on which the electrostatic latent image is formed by the print head 140K.

The print head 140K is an exposing device in which a plurality of light emitting elements such as light emitting diodes (LEDs) or light emitting thyristors is arrayed and the light emitting element corresponding to each pixel of image data from the controller 20 is controlled to be turned ON or OFF to expose a photoreceptor drum 152K to light. The print head 140K includes a light exposure amount controller that controls a light exposure amount for the photoreceptor drum 152 that is an image carrier when forming an electrostatic latent image by controlling the light intensity of light to be emitted from a light emitting device 50 and exposing the photoreceptor drum 152 to light.

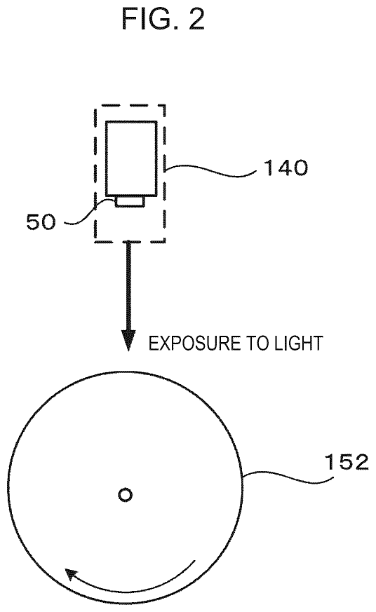

The image forming device 150K includes the photoreceptor drum 152K, a charging device 154K, a developing device 156K, and a cleaning device 158K. The photoreceptor drum 152K is an image carrier that rotates at a predetermined rotational speed along a direction of an arrow in FIG. 2. The charging device 154K uniformly charges the surface of the photoreceptor drum 152K. The developing device 156K develops an electrostatic latent image formed on the photoreceptor drum 152K by light exposure from the exposing device. The photoreceptor drum 152K is uniformly charged by the charging device 154K, and an electrostatic latent image is formed on the photoreceptor drum 152K with light radiated from the print head 140K of the exposing device. The electrostatic latent image formed on the photoreceptor drum 152K is developed with black (K) toner by the developing device 156K, and the toner image is transferred onto the intermediate transfer belt 16. After the toner image is transferred, residual toner, paper dust, etc. adhering to the photoreceptor drum 152K are removed by the cleaning device 158K.

The other image forming units 14Y, 14M, and 14C form yellow (Y), magenta (M), and cyan (C) toner images and transfer the formed color toner images onto the intermediate transfer belt 16 similarly to the above.

On the intermediate transfer belt 16, first transfer rollers 162K, 162Y, 162M, and 162C are disposed to face the image forming units 14K, 14Y, 14M, and 14C, respectively. The color toner images formed on the photoreceptor drums 152K, 152Y, 152M, and 152C are transferred onto the intermediate transfer belt 16 in multiple layers by the first transfer rollers 162. Residual toner adhering to the intermediate transfer belt 16 is removed by a cleaning blade or brush of a belt cleaning device 189 provided downstream of a second transfer position.

At a second transfer position on the sheet transport path 18, a second transfer roller 186 is disposed in press contact with a backup roller 168. The color toner images transferred onto the intermediate transfer belt 16 in multiple layers are secondly transferred onto the recording paper 32 by a press contact force and an electrostatic force of the second transfer roller 186. The recording paper 32 onto which the color toner images are transferred is transported to the fixing device 19 by a transport belt 187 and a transport belt 188.

The fixing device 19 heats and pressurizes the recording paper 32 onto which the color toner images are transferred to melt the toner and fix it to the recording paper 32.

As described above, the intermediate transfer belt 16, the first transfer rollers 162, the second transfer roller 186, the transport belts 187 and 188, the fixing device 19, and other components function as a transferrer that transfers the images developed on the photoreceptor drums 152 by the developing devices 156 onto the recording paper 32 that is a recording medium.

The configuration of each of the print heads 140K, 140Y, 140M, and 140C (hereinafter represented simply by “140”) of the image forming apparatus 10 illustrated in FIG. 1 is described.

As illustrated in FIG. 2, the print head 140 includes the light emitting device 50 including an array of light emitting elements, and performs a light exposure process by irradiating the rotating photoreceptor drum 152 with light based on image data.

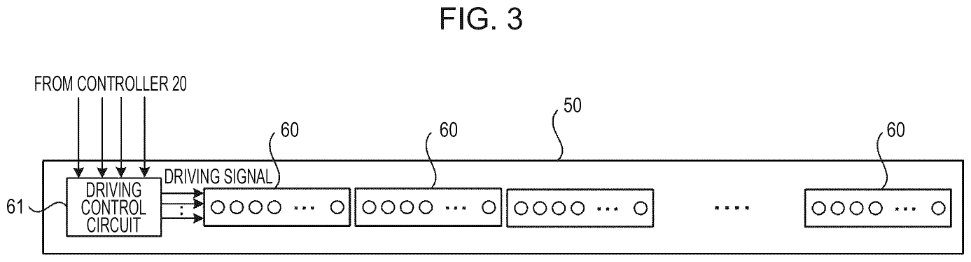

The configuration of the light emitting device 50 illustrated in FIG. 2 is described with reference to FIG. 3. As illustrated in FIG. 3, the light emitting device 50 includes a plurality of light emitting chips 60 each including a plurality of light emitting elements, and a driving control circuit 61 that outputs driving signals to the light emitting chips 60.

The driving control circuit 61 receives signals from the controller 20 and outputs various driving signals to control the light emitting elements of the light emitting chips 60 to be turned ON.

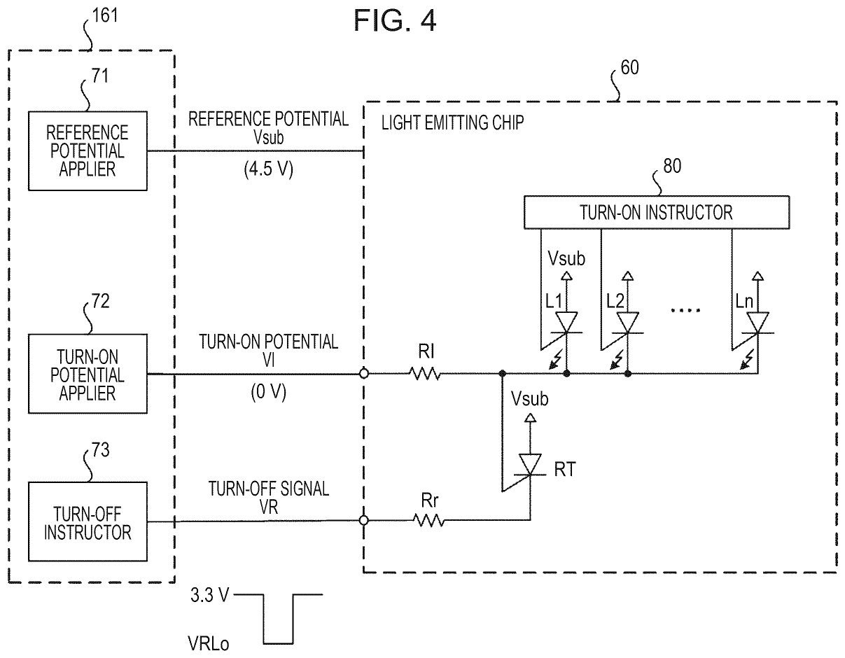

FIG. 4 illustrates the circuit configuration of each light emitting chip 60. As illustrated in FIG. 4, the light emitting chip 60 includes a turn-on instructor 80, a plurality of light emitting thyristors L1 to Ln, at least one turn-off thyristor RT, and current limiting resistors RI and Rr. In the light emitting chip 60 of this exemplary embodiment, the n light emitting thyristors (light emitting elements) L1 to Ln are sequentially turned ON to radiate light, thereby exposing the photoreceptor drum 152 to light. The term “light emitting thyristor L” means each of the plurality of light emitting thyristors L1 to Ln without distinction.

The light emitting thyristors L are light emitting elements in which a reference potential Vsub is applied to anode terminals and cathode terminals are connected to a first end of the current limiting resistor RI in common. The turn-on instructor 80 sequentially outputs turn-on instruction signals to the plurality of light emitting thyristors L to sequentially turn ON the plurality of light emitting thyristors L. The turn-on instruction signal is, for example, a signal at 2.7 V during turn-on instruction and at 0 V not during turn-on instruction. The turn-on instruction signal from the turn-on instructor 80 is input to a gate terminal of the light emitting thyristor L.

Prior to description about the configuration of the driving control circuit 61 for driving the light emitting chip 60, description is made about an operation of a driving control circuit 161 of a comparative example to which the technology of the exemplary embodiment of the present disclosure is not applied.

As illustrated in FIG. 4, the driving control circuit 161 of the comparative example includes a reference potential applier 71, a turn-on potential applier 72, and a turn-off instructor 73.

The reference potential applier 71 applies a reference potential Vsub of, for example, 4.5 V to the light emitting chip 60. The turn-on potential applier 72 applies a turn-on potential VI to a second end of the current limiting resistor RI.

The turn-off instructor 73 outputs a turn-off signal VR to a gate terminal of the turn-off thyristor RT via the current limiting resistor Rr. The turn-off instructor 73 sets the turn-off signal VR to a low level while any one light emitting thyristor L is ON to turn ON the turn-off thyristor RT, thereby turning OFF the light emitting thyristor L in the ON state. That is, when outputting the turn-off signal VR to turn OFF the light emitting thyristor L in the ON state, the turn-off instructor 73 changes the turn-off signal VR at a high level to a low level. Specifically, as illustrated in FIG. 4, the turn-off signal VR is normally at a high level of 3.3 V, and is changed to a low level when turning OFF the light emitting thyristor in the ON state. The potential of the low level of the turn-off signal VR is represented by VRLo. In the driving control circuit 161 of the comparative example, the low level VRLo of the turn-off signal VR output from the turn-off instructor 73 is 0 V. Thus, the turn-off signal VR is a pulse signal at the high level of 3.3 V and the low level VRLo of 0 V.

In the turn-off thyristor RT, the reference potential Vsub is applied to an anode terminal, and a gate terminal is connected to the first end of the current limiting resistor RI. The turn-off signal VR is input to a cathode terminal via the current limiting resistor Rr. When the turn-off signal VR reaches the low level VRLo, the turn-off thyristor RT is switched from OFF to ON, and changes the potentials at the cathode terminals of the plurality of light emitting elements L to potentials at which the plurality of light emitting elements L is turned OFF.

Prior to description about the operation of the light emitting chip 60 illustrated in FIG. 4, basic operations of the thyristor such as the light emitting thyristor L or the turn-off thyristor RT are described.

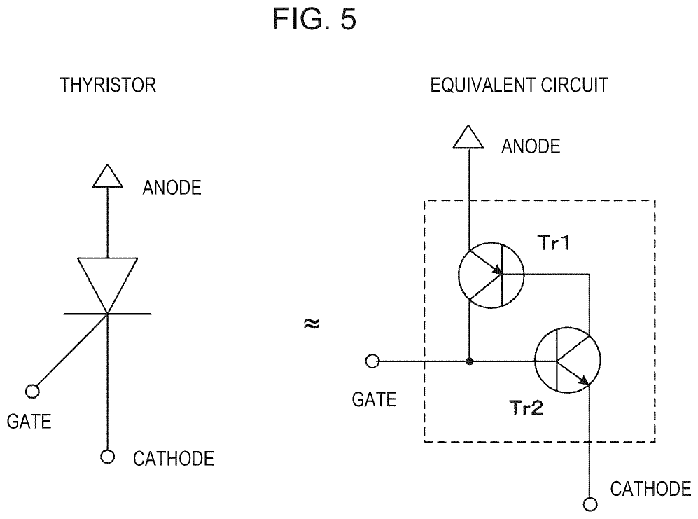

FIG. 5 illustrates an equivalent circuit of the thyristor. The thyristor includes anode, cathode, and gate terminals. When a predetermined voltage or higher is applied between the cathode and the gate, the thyristor is turned ON, and the anode and the cathode are brought into conduction.

As illustrated in FIG. 5, the equivalent circuit of the thyristor is represented as a circuit having a PNP transistor Tr1 and an NPN transistor Tr2 connected together.

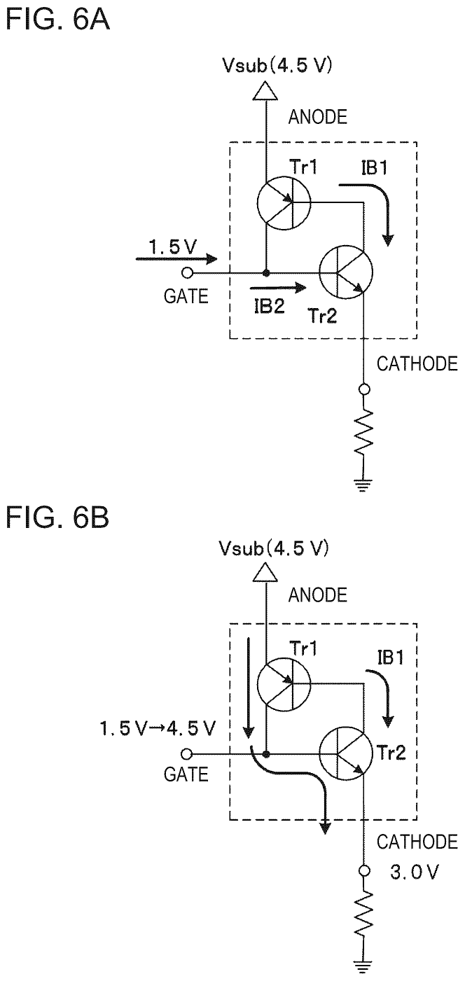

The operations of the equivalent circuit of the thyristor are described with reference to FIGS. 6A and 6B.

As illustrated in FIG. 6A in relation to the equivalent circuit diagram of the thyristor, when 4.5 V is applied to the anode as the reference potential Vsub, the cathode is connected to a ground potential via an appropriate resistance value, and 1.5 V is applied between the cathode and the gate, a base current IB2 flows through the transistor Tr2, and the transistor Tr2 is turned ON. Then, an emitter and a collector of the transistor Tr2 are brought into conduction. A base current IB1 flows through the transistor Tr1, and the transistor Tr1 is turned ON.

As illustrated in FIG. 6B, an emitter and a collector of the transistor Tr1 are brought into conduction. A collector current flows through the transistor Tr1, and serves as the base current of the transistor Tr2.

Therefore, both the transistors Tr1 and Tr2 remain ON, and the anode and the cathode remain in conduction irrespective of the voltage applied to the gate.

In this state, a voltage close to 4.5 V applied to the anode is output to the gate terminal as illustrated in FIG. 6B. This is because the saturation voltage between the collector and the emitter of the transistor Tr1 is very low. The base and the emitter of the transistor Tr2 have a potential difference of 1.5 V that is a forward voltage of PN junction. Therefore, a voltage of 3.0 V obtained by subtracting the voltage of 1.5 V between the base and the emitter of the transistor Tr2 from 4.5 V is output to the cathode.

In the following description, the voltage between the anode and the cathode in the ON state is represented by Von (ON voltage), and is about 1.5 V.

In the thyristor in the conductive state as illustrated in FIG. 6B, the conductive state is maintained until the voltage between the anode and the cathode becomes lower than a retention voltage (1.4 V) or the connection to the reference potential or the ground potential is terminated.

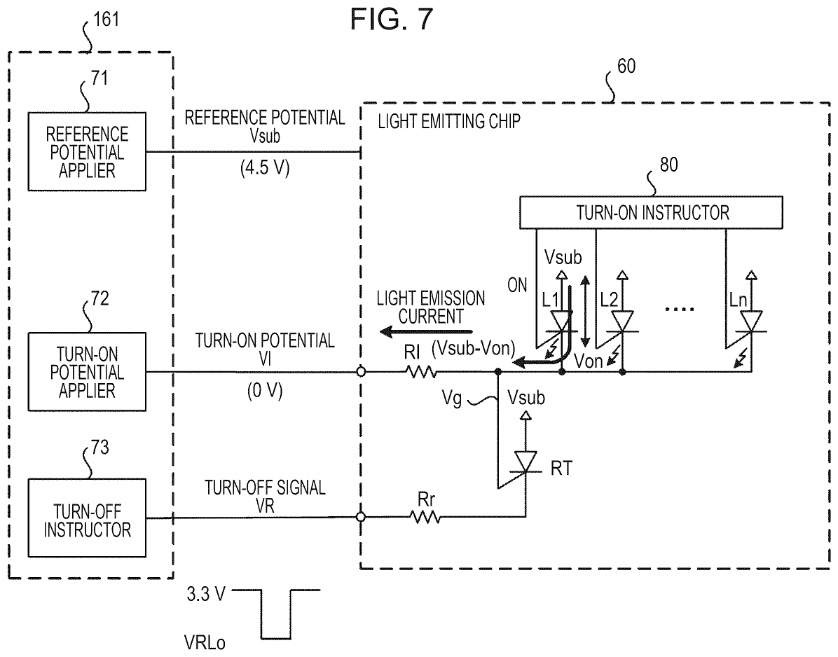

Circuit operations of the light emitting chip 60 are described with reference to FIGS. 7 to 9. The reference potential Vsub of 4.5 V is applied to the light emitting chip 60. The reference potential Vsub is applied to the anode terminals of the light emitting thyristors L and the turn-off thyristor RT. A turn-on potential VI of 0 V is applied to the second end of the current limiting resistor RI.

(1) FIG. 7 illustrates a state in which the light emitting thyristor L1 is turned ON and lit by the turn-on instruction signal from the turn-on instructor 80. Since the light emitting thyristor L1 is turned ON, a light emission current flows through the current limiting resistor RI via the light emitting thyristor L1. The current value of the light emission current may be calculated based on an expression “(Vsub−VI−Von)/RI.” A voltage Vg at the gate terminal of the turn-off thyristor RT is expressed by Vsub−Von. The voltage Von is the ON voltage of the light emitting thyristor L1. Since Von is 1.5 V as described above, Vg=Vsub−Von=4.5−1.5=3 V in the following description.

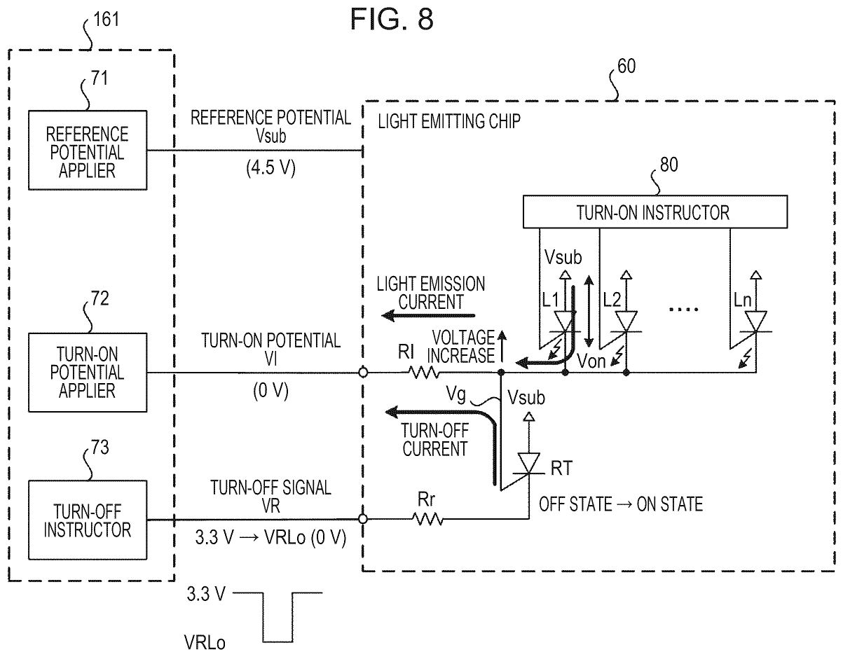

(2) FIG. 8 illustrates a state in which the turn-off signal VR is changed to the low-level voltage VRLo (0 V). Since the turn-off signal VR is changed to the low-level voltage VRLo (0 V), the voltage between the cathode terminal and the gate terminal of the turn-off thyristor RT is expressed by Vg−VRLo. Since Vg is 3 V and VRLo is 0 V, Vg−VRLo=3 V. That is, the voltage between the cathode terminal and the gate terminal of the turn-off thyristor RT is 3 V, and is higher than the ON voltage (threshold voltage) of 1.5 V. Therefore, the turn-off thyristor RT is turned ON. As a result, a turn-off current flows from the gate terminal of the turn-off thyristor RT to the current limiting resistor RI, and the voltage Vg at the gate terminal increases.

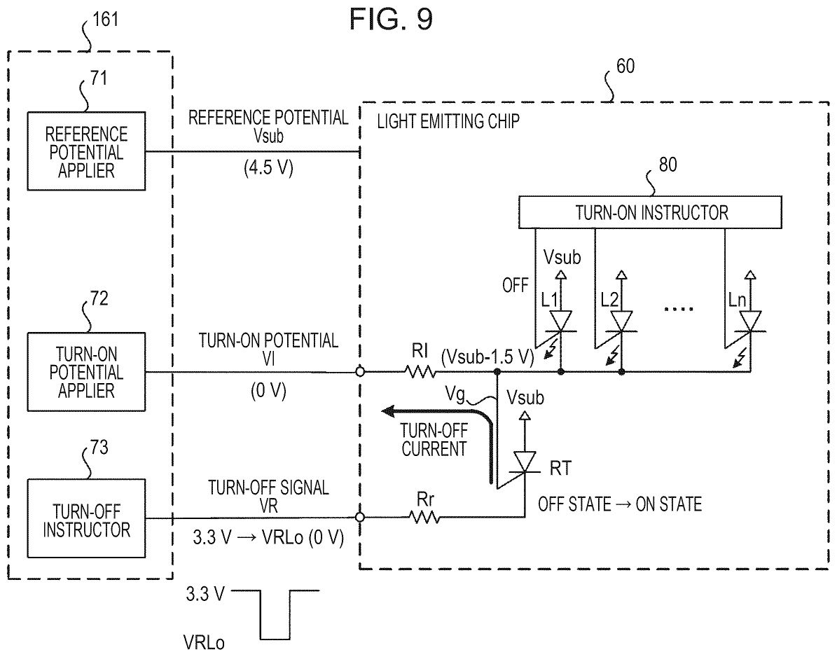

(3) FIG. 9 illustrates a state in which the voltage Vg at the gate terminal increases and the light emitting thyristor L1 is turned OFF. When the turn-off thyristor RT is turned ON and the voltage Vg at the gate terminal increases as described above, the voltage at the cathode terminal of the light emitting thyristor L1 increases as well. When the voltage between the anode terminal and the cathode terminal of the light emitting thyristor L1 is lower than the retention voltage of 1.4 V, the light emitting thyristor L1 is turned OFF. That is, when the voltage at the cathode terminal of the light emitting thyristor L1 increases to Vsub−1.5 V, that is, 3.0 V or higher, the light emitting thyristor L1 is turned OFF.

When the turn-on instructor 80 outputs the turn-on instruction signal to the light emitting thyristor L2 after the light emitting thyristor L1 has been turned ON and OFF through the operations illustrated in FIGS. 7 to 9, the light emitting thyristor L2 is turned ON. Such operations are sequentially performed on the light emitting thyristors L1, L2, L3, . . . . Thus, the light emitting thyristors L1 to Ln sequentially emit light.

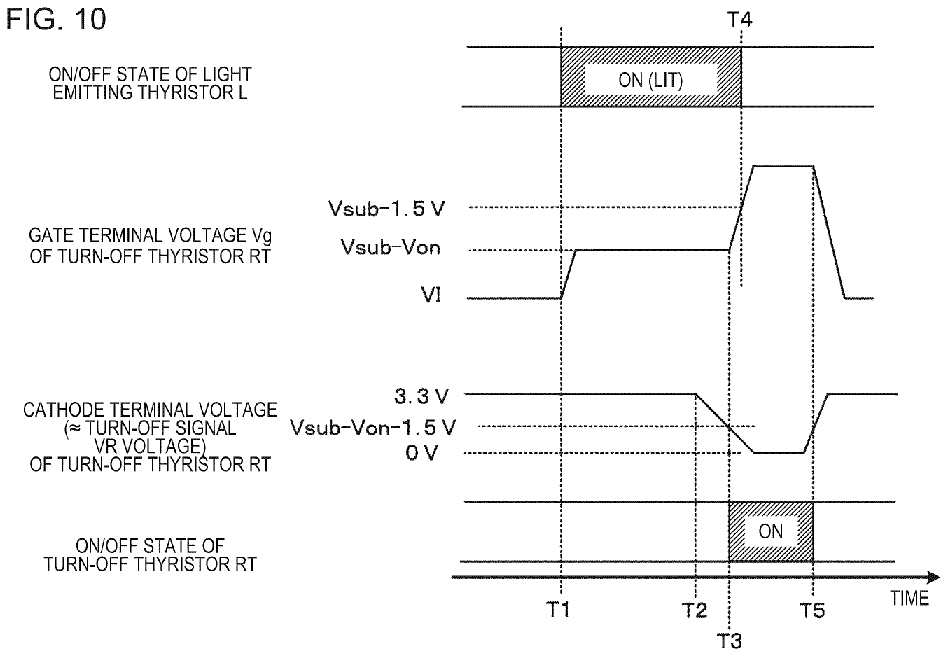

The timing chart of FIG. 10 illustrates voltage changes in the operations of the light emitting chip 60 illustrated in FIGS. 7 to 9.

When the light emitting thyristor L1 is turned ON at a time T1, the voltage Vg at the gate terminal of the turn-off thyristor RT increases to the voltage expressed by Vsub−Von. When the turn-off signal VR is changed to the low-level voltage VRLo at a time T2, the voltage at the cathode terminal of the turn-off thyristor RT decreases. When the voltage at the cathode terminal becomes equal to or lower than a voltage expressed by Vsub−Von−1.5 V at a time T3, the turn-off thyristor RT is turned ON. As a result, the voltage Vg at the gate terminal increases. When the voltage Vg at the gate terminal becomes equal to or higher than a voltage expressed by Vsub−1.5 V at a time T4, the light emitting thyristor L1 is turned OFF. When the turn-off signal VR is changed to the high level of 3.3 V, the turn-off thyristor RT is turned OFF at a time T5.

In the comparative example described above, the reference potential Vsub from the driving control circuit 161 is fixed to 4.5 V and the turn-on potential VI is fixed to 0 V. Therefore, the current value of the light emission current that flows when the light emitting thyristor L is turned ON is fixed to the value expressed by (Vsub−VI−Von)/RI. That is, the light intensity of the light emitting thyristor L is fixed.

In the print head 140 including the light emitting device 50 including the light emitting chips 60, however, there is a demand to adjust the light exposure amount by changing the light intensity. To adjust the light intensity of the light emitting thyristor L, the reference potential Vsub or the turn-on potential VI needs to be changed. When the reference potential Vsub or the turn-on potential VI is changed, however, turn-off failure of the light emitting thyristor L or erroneous turn-on failure of the turn-off thyristor RT may occur. The turn-off failure of the light emitting thyristor L refers to a state in which the turn-off thyristor RT is not turned ON and the light emitting thyristor L is not turned OFF. The erroneous turn-on failure of the turn-off thyristor RT refers to a state in which the turn-off thyristor RT is erroneously turned ON in an unwanted period.

In order not to turn ON the turn-off thyristor RT, the turn-off signal VR is set to the high level of 3.3 V. As illustrated in FIG. 3, however, the light emitting device 50 includes the plurality of light emitting chips 60, and the turn-off signal VR is input to the plurality of light emitting chips 60 in common. Therefore, when the turn-off signal VR is set to the low-level voltage VRLo for the light emitting chip 60 in which the light emitting thyristor L is ON, the turn-off signal VR is also the low-level voltage VRLo for the other light emitting chips 60 in which the light emitting thyristors L are not ON. Thus, when the light emitting thyristor L is not ON, it is necessary that the turn-off thyristor RT is not turned ON even if the turn-off signal VR is VRLo. This because, when the turn-off thyristor RT is turned ON though the light emitting thyristor L is not ON, an unwanted turn-off current flows and the power consumption increases in the light emitting device 50 as a whole. Accordingly, it is necessary to prevent the erroneous turn-on failure in which the turn-off thyristor RT is erroneously turned ON in an unwanted period.

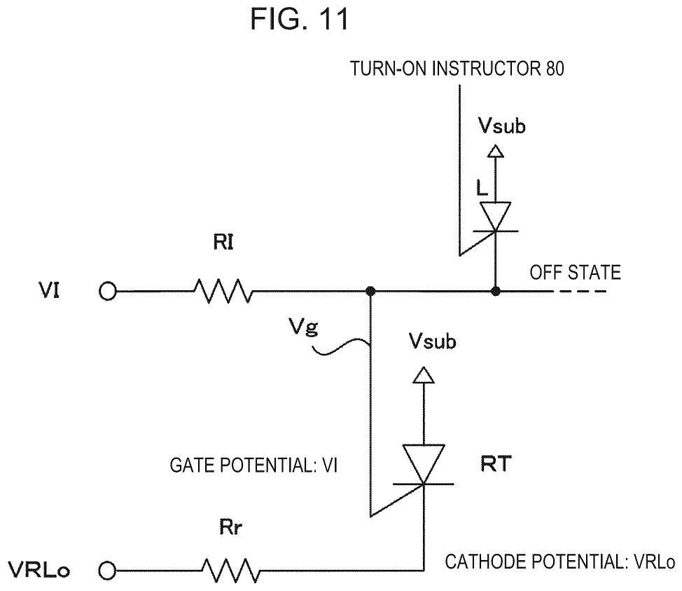

A condition under which the erroneous turn-on failure of the turn-off thyristor RT occurs is described with reference to FIG. 11.

When the light emitting thyristor L is not ON, no current flows through the current limiting resistor RI, and therefore the gate potential of the turn-off thyristor RT is equal to VI. When the voltage between the gate potential VI and the cathode potential of the turn-off thyristor RT is higher than 1.5 V, the turn-off thyristor RT is turned ON. In the comparative example described above, the turn-on potential VI is 0 V and VRLo is 0 V. Therefore, the turn-off thyristor RT is not turned ON as long as the light emitting thyristor L is not ON even though VRLo is 0 V. When adjusting the turn-on potential VI to adjust the light intensity of the light emitting thyristor L, however, the variable range of the turn-on potential VI has an upper limit to prevent the erroneous turn-on failure. Specifically, the erroneous turn-on failure occurs when VRLo is 0 V and the turn-on potential VI is set to 1.5 V or higher. That is, the upper limit of the variable range of the turn-on potential VI is 1.5 V.

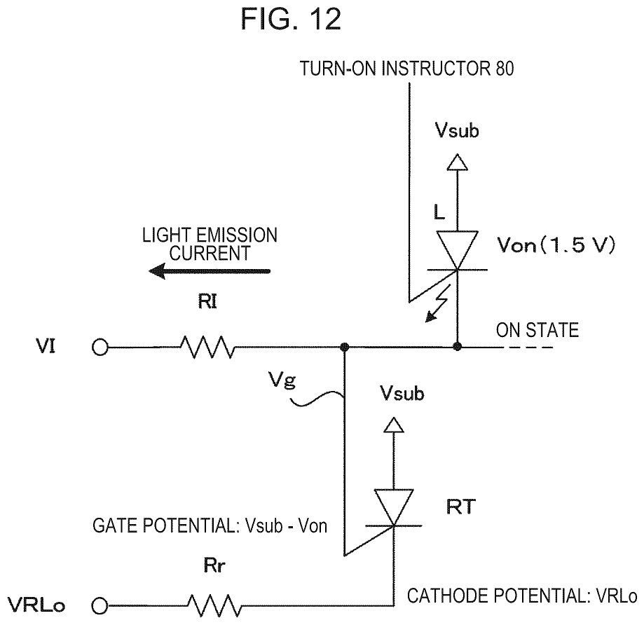

A voltage range in which the turn-off thyristor RT is securely turned ON and the turn-off failure of the light emitting thyristor L does not occur is described with reference to FIG. 12.

When the light emitting thyristor L is ON and the voltage difference between the voltage Vg at the gate terminal and the voltage at the cathode terminal is larger than 1.5 V, the turn-off thyristor RT is turned ON and turns OFF the light emitting thyristor L. The voltage VRLo of the turn-off signal is applied to the cathode terminal of the turn-off thyristor RT. Therefore, the turn-off failure does not occur when the voltage obtained by subtracting VRLo from the voltage Vg at the gate terminal is 1.5 V. The voltage Vg at the gate terminal is expressed by Vsub−Von. Thus, the condition under which the turn-off failure does not occur is satisfaction of the following expression.

$$Vsub - Von - VRLo > 1.5 V$$

Assuming that Von=1.5 V, the condition under which the turn-off failure does not occur is satisfaction of the following expression.

$$Vsub - VRLo > 3. V$$

That is, when the low-level voltage VRLo of the turn-off signal VR is 0 V, the reference potential Vsub is adjusted under the condition that the turn-off failure does not occur. Then, the lower limit of the variable range is 3.0 V.

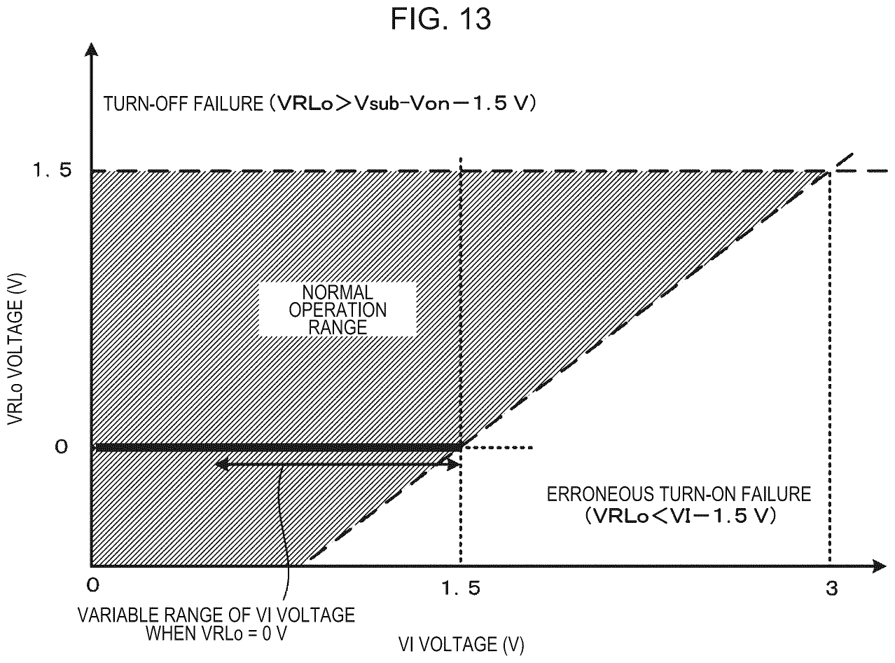

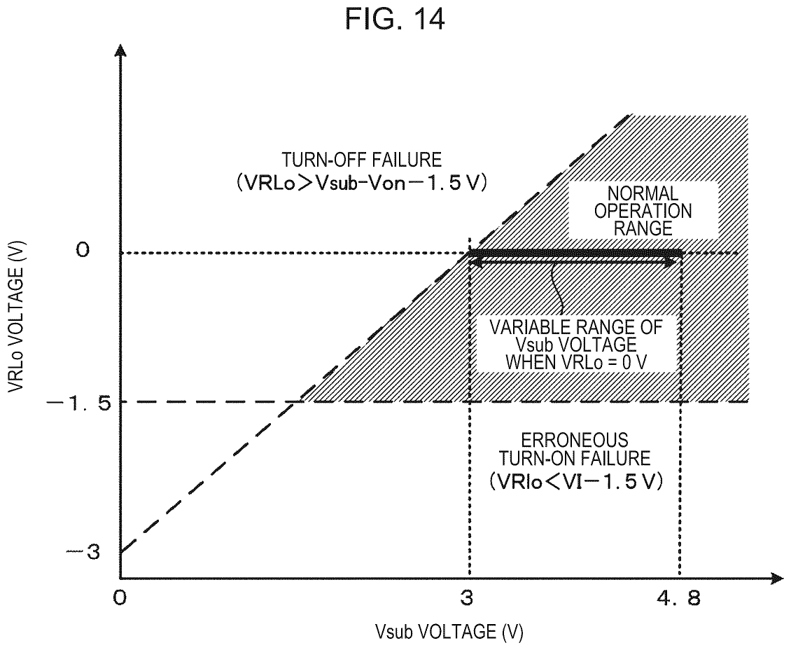

FIGS. 13 and 14 illustrate the variable ranges adjustable when the voltage of the turn-on potential VI and the voltage of the reference potential Vsub are variable based on the conditions described above. FIG. 13 illustrates a normal operation range in which neither the turn-off failure nor the erroneous turn-on failure occurs when the reference potential Vsub is fixed to 4.5 V and the voltage of the turn-on potential VI is variable. FIG. 14 illustrates a normal operation range in which neither the turn-off failure nor the erroneous turn-on failure occurs when the turn-on potential VI is fixed to 0 V and the voltage of the reference potential Vsub is variable.

FIG. 13 demonstrates that the upper limit of the variable range of the voltage of the turn-on potential VI when VRLo=0 V is 1.5 V due to the erroneous turn-on failure. When the VRLo voltage increases from 0 V, the upper limit of the variable range of the voltage of the turn-on potential VI increases accordingly. The upper limit of the VRLo voltage is 1.5 V due to the condition that the turn-off failure does not occur.

FIG. 14 demonstrates that the variable range of the voltage of the reference potential Vsub has the lower limit due to the condition that the turn-off failure does not occur. For example, when VRLo=0 V, the lower limit of the Vsub voltage is 3 V. When the VRLo voltage is lower than 0 V, the lower limit of the Vsub voltage decreases accordingly. The lower limit of the VRLo voltage is −1.5 V due to the condition that the erroneous turn-on failure does not occur. If the anode voltage is excessively high, malfunction occurs due to an overcurrent etc. For example, an internal resistance of a semiconductor layer is present between the anode and the gate of the turn-off thyristor RT in actuality. Therefore, when the anode voltage increases, the current flowing from the gate to the current limiting resistor RI is limited. Thus, the gate potential decreases from 4.5 V and the light emitter is not turned OFF. In FIG. 14, the upper limit of the anode voltage at which the light emitter is not turned OFF is 4.8 V.

As described above, when the low-level voltage VRLo of the turn-off signal VR is fixed to 0 V, the variable ranges of the voltages of the reference potential Vsub and the turn-on potential VI are limited even when adjusting the light exposure amount by changing the light intensity of the light emitting thyristor L. In view of this, the light emitting device 50 of this exemplary embodiment has the following circuit configuration.

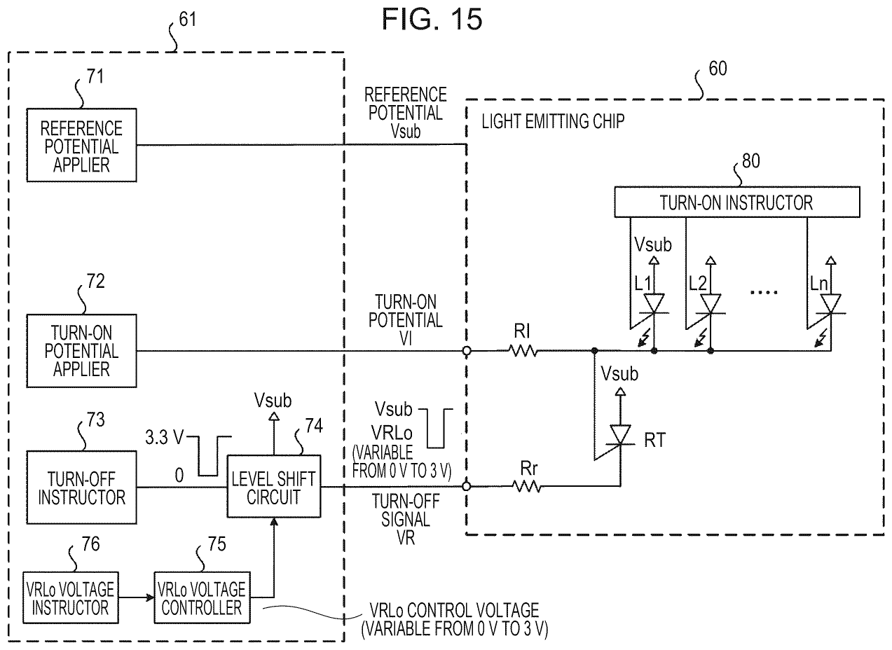

The configuration of the driving control circuit 61 of the light emitting device 50 of this exemplary embodiment is described with reference to FIG. 15. Since the circuit configuration of the light emitting chip 60 in FIG. 15 has been described with reference to FIG. 4 etc., detailed description thereof is omitted.

As illustrated in FIG. 15, the driving control circuit 61 of this exemplary embodiment includes a level shift circuit 74, a VRLo voltage controller 75, and a VRLo voltage instructor 76 in addition to the reference potential applier 71, the turn-on potential applier 72, and the turn-off instructor 73. Since the reference potential applier 71, the turn-on potential applier 72, and the turn-off instructor 73 in FIG. 15 are the same as those in FIG. 4, description thereof is omitted.

The level shift circuit 74 changes the low-level voltage VRLo of the turn-off signal VR according to the turn-on potential VI. Specifically, the level shift circuit 74 changes the low-level voltage VRLo of the turn-off signal VR to increase as the turn-on potential VI increases.

The VRLo voltage instructor 76 gives an instruction for a voltage value of the low-level voltage VRLo of the turn-off signal VR. The VRLo voltage controller 75 generates a VRLo control voltage according to the voltage value under the instruction from the VRLo voltage instructor 76. The variable range of the VRLo control voltage is, for example, a range from 0 V to 3 V.

The level shift circuit 74 changes the low-level voltage VRLo of the turn-off signal VR so that the low-level voltage VRLo of the turn-off signal VR reaches the VRLo control voltage.

In this exemplary embodiment, the turn-off signal VR having the low-level voltage VRLo changed by the level shift circuit 74 is input to the cathode terminal. In this exemplary embodiment as well, the turn-off thyristor RT is switched from OFF to ON when the turn-off signal VR reaches the low level VRLo, and changes the potentials at the cathode terminals of the plurality of light emitting thyristors L1 to Ln to the potentials at which the light emitting thyristors L in the ON state are turned OFF.

The level shift circuit 74 changes the low-level voltage VRLo of the turn-off signal VR continuously or stepwise according to the voltage value of the turn-on potential VI based on the VRLo control voltage from the VRLo voltage controller 75. Therefore, even when adjusting the light intensity by changing the voltage of the turn-on potential VI, the voltage at which the erroneous turn-on failure does not occur is set as the VRLo voltage according to the voltage of the turn-on potential VI.

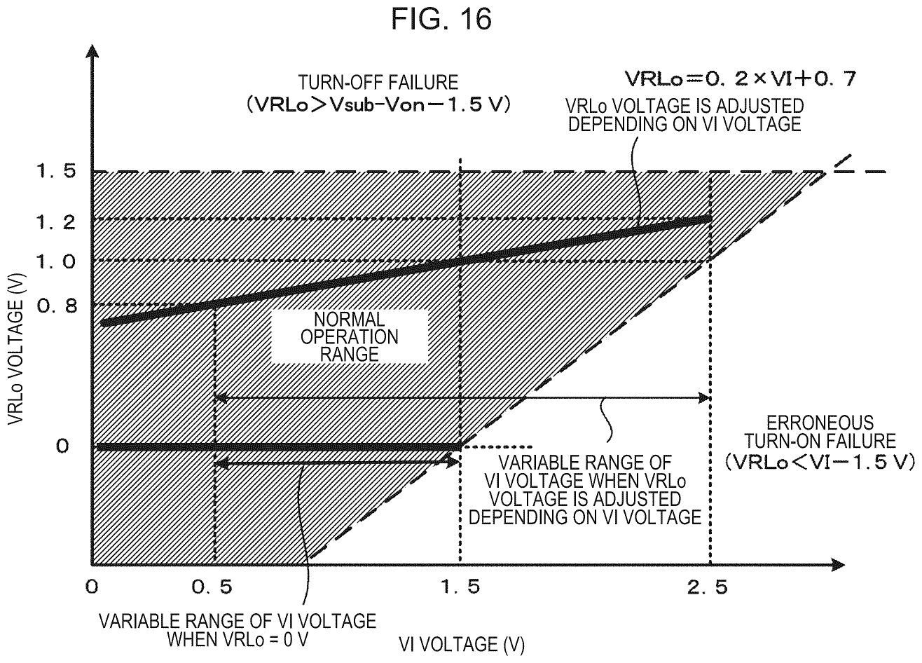

FIG. 16 illustrates the variable range of the voltage of the turn-on potential VI when the VRLo voltage is adjusted according to the voltage of the turn-on potential VI. FIG. 16 illustrates a case where the VRLo voltage is adjusted based on an expression “VRLo=0.2×VI+0.7 (V).” That is, when the VI voltage is 0.5 V, 1.5 V, and 2.5 V, the VRLo voltage is set to 0.8 V, 1.0 V, and 1.2 V, respectively.

As illustrated in FIG. 16, when the low-level voltage VRLo of the turn-off signal VR is fixed to 0 V, the upper limit of the turn-on potential VI is 1.5 V. In FIG. 16, the VRLo voltage is increased along with the increase in the turn-on potential VI. Therefore, when the turn-on potential VI is set to 2.5 V, the low-level voltage VRLo of the turn-off signal VR increases to 1.2 V.

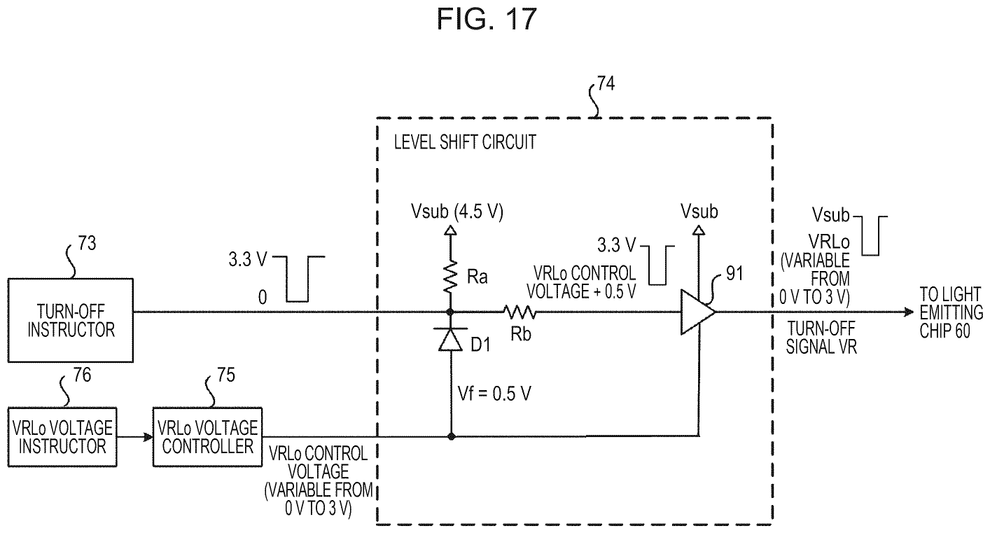

FIG. 17 illustrates an example of a specific circuit configuration of the level shift circuit 74 illustrated in FIG. 15. As illustrated in FIG. 17, the level shift circuit 74 includes resistance elements Ra and Rb, a diode D1, and a buffer circuit 91.

In the buffer circuit 91, a power supply terminal is connected to the reference potential Vsub, and a ground terminal is connected to the VRLo control voltage from the VRLo voltage controller 75. Therefore, the low-level voltage of the turn-off signal VR to be output from the buffer circuit 91 is converted into the VRLo control voltage from the VRLo voltage controller 75. The high-level voltage of the turn-off signal VR to be output from the buffer circuit 91 is converted into the voltage of the reference potential Vsub.

Depending on the type of the buffer circuit 91, the buffer circuit 91 may have a circuit configuration in which a signal at a voltage lower than the voltage applied to the ground terminal is not allowed as the input signal. Therefore, the level shift circuit 74 illustrated in FIG. 17 has the circuit including the resistance elements Ra and Rb and the diode D1 to increase the low-level voltage of the input signal from the turn-off instructor 73. For example, the resistance value of the resistance element Ra is 500 Ω, the resistance value of the resistance element Rb is 50 Ω, and a forward voltage Vf of the diode D1 is 0.5 V. Even when the low-level voltage of the turn-off signal VR from the turn-off instructor 73 is 0 V, the low-level voltage of the signal to be input to the buffer circuit 91 is increased to a voltage obtained by adding 0.5 V to the VRLo control voltage.

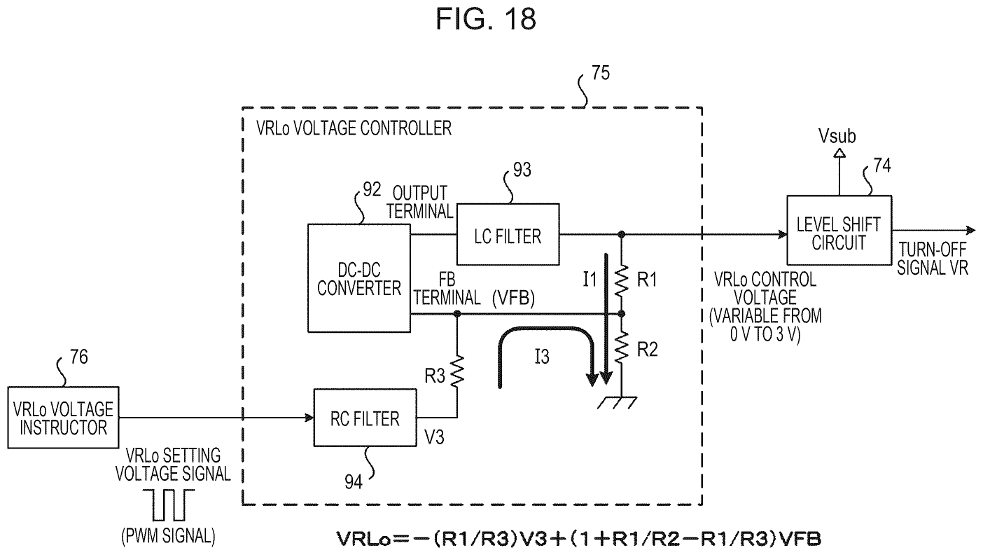

FIG. 18 illustrates an example of a specific circuit configuration of the VRLo voltage controller 75 illustrated in FIG. 15. As illustrated in FIG. 18, the VRLo voltage controller 75 includes resistance elements R1, R2, and R3, a DC-DC converter 92, an LC filter 93, and an RC filter 94.

The VRLo control voltage to be output from the VRLo voltage controller 75 is set by a VRLo setting voltage signal output from the VRLo voltage instructor 76. The VRLo voltage instructor 76 outputs a PWM signal having a changed duty ratio to the VRLo voltage controller 75 as the VRLo setting voltage signal.

In response to the VRLo setting voltage signal from the VRLo voltage instructor 76, the VRLo voltage controller 75 generates the VRLo control voltage for changing the low-level voltage VRLo of the turn-off signal VR, and supplies the VRLo control voltage to the level shift circuit 74.

Details of the operations of the VRLo voltage controller 75 are described.

As preconditions, the DC-DC converter 92 has an output terminal and a feedback (FB) terminal, and the FB terminal voltage is a constant voltage VFB. The RC filter 94 cuts off a high-frequency component of the VRLo setting voltage signal from the VRLo voltage instructor 76 to convert the signal into a V3 voltage that is a DC voltage.

The VRLo voltage controller 75 generates the VRLo control voltage through the following operations (1) to (3).
(1) A current I3 flows from the FB terminal to the resistance element R2 according to a potential difference (VFB−V3) at both ends of the resistance element R3.
(2) Since the voltage at the FB terminal is fixed to VFB, a current I1 flows from the resistance element R1 to the resistance element R2 so that the potential difference at both ends of the resistance element R2 becomes VFB.
(3) A voltage obtained by adding a potential difference (R1×I1) at both ends of the resistance element R1 to the voltage VFB at the FB terminal is set as the VRLo control voltage.

The voltage value of the VRLo control voltage is calculated by the following expression based on the operations (1) to (3).

$$VRLo = - ( R 1 / R 3 ) V 3 + ( 1 + R 1 / R 2 - R 1 / R 3 ) VFB$$

The above expression becomes as follows, for example, when R1=20 KΩ, R2=R3=50 KΩ, and VFB=0.8 V.

$$VRLo = - 0.4 \times V 3 + 1.44$$

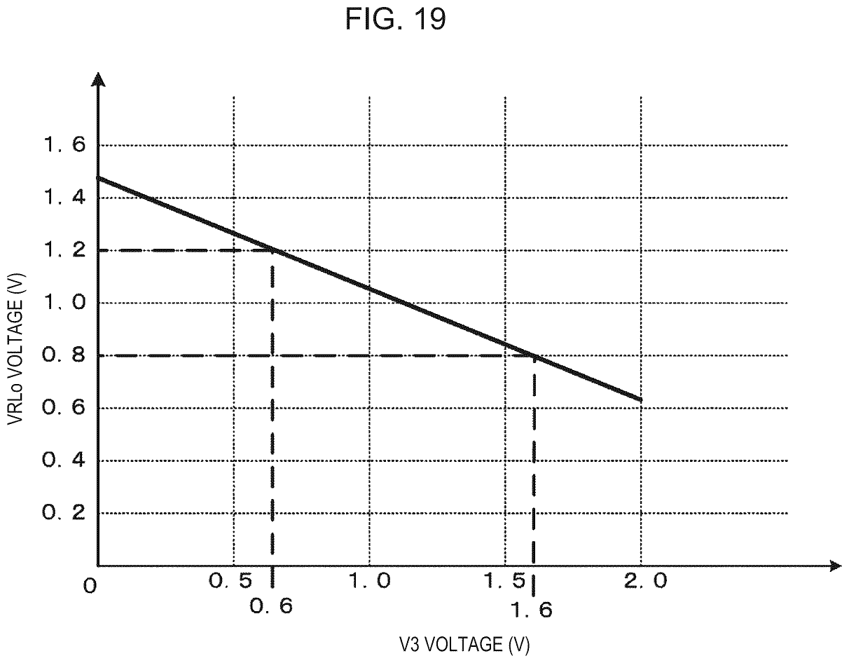

FIG. 19 illustrates the relationship between the VRLo control voltage set by the above expression and the V3 voltage. FIG. 19 illustrates an example of setting of the VRLo control voltage relative to the V3 voltage. FIG. 19 demonstrates that the VRLo control voltage is 1.2 V when the V3 voltage is set to 0.6 V, and the VRLo control voltage is 0.8 V when the V3 voltage is set to 1.6 V. That is, the VRLo control voltage may be changed between 0.8 V and 1.2 V as illustrated in FIG. 16 by changing the V3 voltage between 0.6 V and 1.6 V.

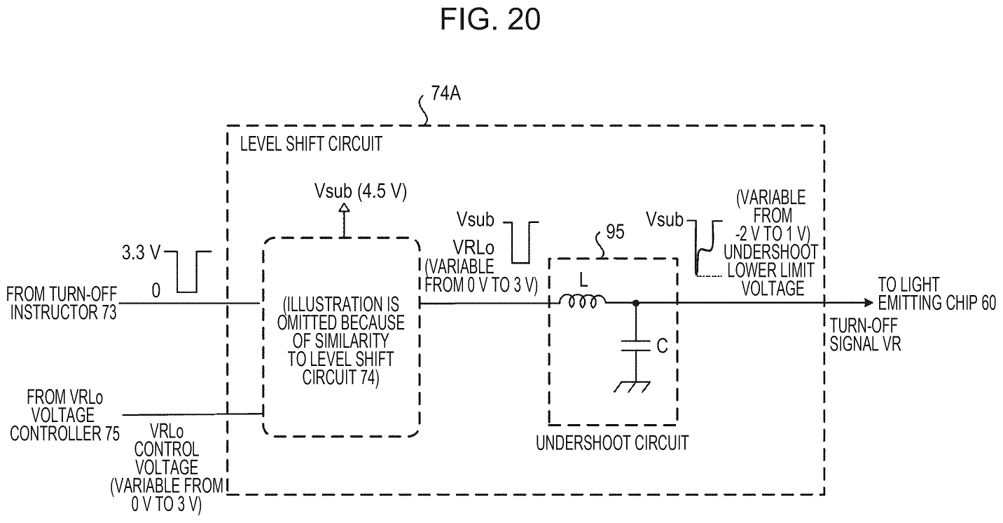

The circuit configuration of a level shift circuit 74A as a modification of the level shift circuit 74 illustrated in FIG. 17 is described with reference to FIG. 20. In FIG. 20, illustration is omitted for the same circuit configuration as that of the level shift circuit 74 illustrated in FIG. 17.

The level shift circuit 74A illustrated in FIG. 20 is obtained by adding an undershoot circuit 95 to the level shift circuit 74 illustrated in FIG. 17.

The undershoot circuit 95 causes an undershoot of a waveform that is below a baseline of a steady-state value at a falling edge of the waveform of the turn-off signal VR after the low-level voltage VRLo has been changed. Specifically, the undershoot circuit 95 includes a coil element L connected in series to the turn-off instructor 73, and a capacitive element C connected between the coil element L and the ground. As specific examples of constants of the undershoot circuit 95, L=30 nH and C=100 pF.

With this circuit configuration, the VRLo voltage that has reached the VRLo control voltage is instantaneously reduced to a voltage equal to or lower than the VRLo voltage. For example, the undershoot circuit 95 instantaneously causes an undershoot of −2 V for the VRLo voltage that changes from 0 V to 3 V. Thus, the VRLo voltage is instantaneously reduced to an undershoot lower limit voltage of −2 V to 1 V.

In the level shift circuit 74 illustrated in FIG. 17, the low-level voltage VRLo of the turn-off signal VR is not settable to a value lower than 0 V. However, the level shift circuit 74A including the undershoot circuit 95 may instantaneously set the low-level voltage VRLo of the turn-off signal VR to a value lower than 0 V. The turn-off thyristor RT may turn OFF the light emitting thyristor L in the ON state when the turn-off thyristor RT is turned ON even instantaneously.

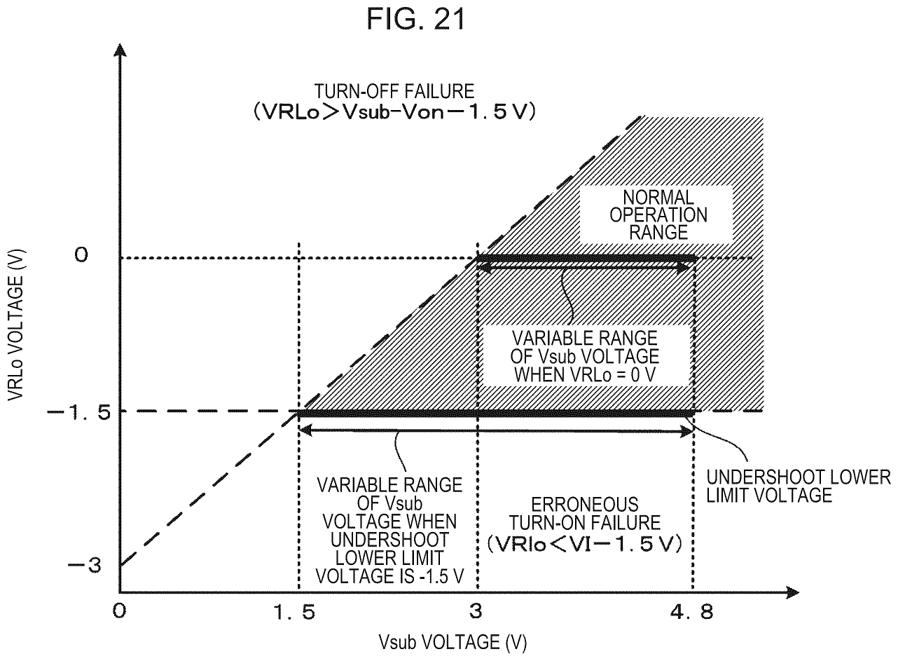

FIG. 21 illustrates the variable range of the voltage of the reference potential Vsub when the undershoot circuit 95 is used. FIG. 21 illustrates how the lower limit voltage of Vsub changes when the undershoot lower limit voltage is set to −1.5 V. Specifically, when VRLo is 0 V, the lower limit of the variable range of the reference potential Vsub at which the turn-off failure does not occur is 3 V. When the undershoot lower limit voltage is set to −1.5 V, the lower limit of the variable range of the reference potential Vsub is 1.5 V.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A light emitting device comprising:
a plurality of light emitting elements including anode terminals to which a reference potential is applied, and cathode terminals connected to a first end of a current limiting resistor in common;
a turn-on instructor configured to sequentially output turn-on instruction signals to the plurality of light emitting elements to sequentially turn ON the plurality of light emitting elements;
a turn-on potential applier configured to apply a turn-on potential to a second end of the current limiting resistor;
a turn-off instructor configured to, when turning OFF a light emitting element in an ON state, output a turn-off signal while changing the turn-off signal from a high level to a low level;
a level shift circuit configured to change a low-level voltage of the turn-off signal according to the turn-on potential; and
at least one turn-off thyristor including an anode terminal to which the reference potential is applied, a gate terminal connected to the first end of the current limiting resistor, and a cathode terminal to which the turn-off signal having the low-level voltage changed by the level shift circuit is input, the at least one turn-off thyristor being configured to be switched from OFF to ON when the turn-off signal reaches the low level, and change potentials at the cathode terminals of the plurality of light emitting elements to potentials at which the plurality of light emitting elements is turned OFF.
(((2)))

The light emitting device according to (((1))), wherein the plurality of light emitting elements is light emitting thyristors including anode terminals to which the reference potential is applied, cathode terminals connected to the first end of the current limiting resistor in common, and gate terminals to which the turn-on instruction signals are input.
(((3)))

The light emitting device according to (((1))) or (((2))), wherein the level shift circuit is configured to change the low-level voltage of the turn-off signal to increase as the turn-on potential increases.
(((4)))

The light emitting device according to (((3))), further comprising:
a voltage instructor configured to give an instruction for a value of the low-level voltage of the turn-off signal; and
a voltage controller configured to generate a control voltage according to the value of the low-level voltage under the instruction from the voltage instructor, wherein:
the level shift circuit is configured to change the low-level voltage of the turn-off signal so that the low-level voltage of the turn-off signal reaches the control voltage.
(((5))

The light emitting device according to any one of (((1))) to (((4))), wherein the level shift circuit includes an undershoot circuit configured to cause an undershoot of a waveform that is below a baseline of a steady-state value at a falling edge of the waveform of the turn-off signal after the low-level voltage has been changed.
(((6)))

The light emitting device according to (((5))), wherein the undershoot circuit includes a coil element connected in series to the turn-off instructor, and a capacitive element connected between the coil element and a ground.
(((7)))

An exposing device comprising:
a light emitting device including:
   a plurality of light emitting elements including anode terminals to which a reference potential is applied, and cathode terminals connected to a first end of a current limiting resistor in common;
   a turn-on instructor configured to sequentially output turn-on instruction signals to the plurality of light emitting elements to sequentially turn ON the plurality of light emitting elements;
   a turn-on potential applier configured to apply a turn-on potential to a second end of the current limiting resistor;
   a turn-off instructor configured to, when turning OFF a light emitting element in an ON state, output a turn-off signal while changing the turn-off signal from a high level to a low level;
   a level shift circuit configured to change a low-level voltage of the turn-off signal according to the turn-on potential; and
   at least one turn-off thyristor including an anode terminal to which the reference potential is applied, a gate terminal connected to the first end of the current limiting resistor, and a cathode terminal to which the turn-off signal having the low-level voltage changed by the level shift circuit is input, the at least one turn-off thyristor being configured to be switched from OFF to ON when the turn-off signal reaches the low level, and change potentials at the cathode terminals of the plurality of light emitting elements to potentials at which the plurality of light emitting elements is turned OFF; and
a light exposure amount controller configured to control a light exposure amount of light exposure on an image carrier for formation of an electrostatic latent image by controlling a light intensity of light to be emitted from the light emitting device.
(((8)))

An image forming apparatus comprising:
an exposing device including:
   a light emitting device including:
      a plurality of light emitting elements including anode terminals to which a reference potential is applied, and cathode terminals connected to a first end of a current limiting resistor in common;
      a turn-on instructor configured to sequentially output turn-on instruction signals to the plurality of light emitting elements to sequentially turn ON the plurality of light emitting elements;
      a turn-on potential applier configured to apply a turn-on potential to a second end of the current limiting resistor;
      a turn-off instructor configured to, when turning OFF a light emitting element in an ON state, output a turn-off signal while changing the turn-off signal from a high level to a low level;
      a level shift circuit configured to change a low-level voltage of the turn-off signal according to the turn-on potential; and
      at least one turn-off thyristor including an anode terminal to which the reference potential is applied, a gate terminal connected to the first end of the current limiting resistor, and a cathode terminal to which the turn-off signal having the low-level voltage changed by the level shift circuit is input, the at least one turn-off thyristor being configured to be switched from OFF to ON when the turn-off signal reaches the low level, and change potentials at the cathode terminals of the plurality of light emitting elements to potentials at which the plurality of light emitting elements is turned OFF; and
   a light exposure amount controller configured to control a light exposure amount of light exposure on an image carrier for formation of an electrostatic latent image by controlling a light intensity of light to be emitted from the light emitting device;
a developing device configured to develop the electrostatic latent image on the image carrier that has been exposed to the light by the exposing device; and
a transferrer configured to transfer, onto a recording medium, an image on the image carrier that has been developed by the developing device.

What is claimed is:

1. A light emitting device comprising:
a plurality of light emitting elements including anode terminals to which a reference potential is applied, and cathode terminals connected to a first end of a current limiting resistor in common;
a turn-on instructor configured to sequentially output turn-on instruction signals to the plurality of light emitting elements to sequentially turn ON the plurality of light emitting elements;
a turn-on potential applier configured to apply a turn-on potential to a second end of the current limiting resistor;
a turn-off instructor configured to, when turning OFF a light emitting element in an ON state, output a turn-off signal while changing the turn-off signal from a high level to a low level;
a level shift circuit configured to change a low-level voltage of the turn-off signal according to the turn-on potential; and
at least one turn-off thyristor including an anode terminal to which the reference potential is applied, a gate terminal connected to the first end of the current limiting resistor, and a cathode terminal to which the turn-off signal having the low-level voltage changed by the level shift circuit is input, the at least one turn-off thyristor being configured to be switched from OFF to ON when the turn-off signal reaches the low level, and change potentials at the cathode terminals of the plurality of light emitting elements to potentials at which the plurality of light emitting elements is turned OFF.

2. The light emitting device according to claim 1, wherein the plurality of light emitting elements is light emitting thyristors including anode terminals to which the reference potential is applied, cathode terminals connected to the first end of the current limiting resistor in common, and gate terminals to which the turn-on instruction signals are input.

3. The light emitting device according to claim 1, wherein the level shift circuit is configured to change the low-level voltage of the turn-off signal to increase as the turn-on potential increases.

4. The light emitting device according to claim 3, further comprising:
a voltage instructor configured to give an instruction for a value of the low-level voltage of the turn-off signal; and
a voltage controller configured to generate a control voltage according to the value of the low-level voltage under the instruction from the voltage instructor, wherein:
the level shift circuit is configured to change the low-level voltage of the turn-off signal so that the low-level voltage of the turn-off signal reaches the control voltage.

5. The light emitting device according to claim 1, wherein the level shift circuit includes an undershoot circuit configured to cause an undershoot of a waveform that is below a baseline of a steady-state value at a falling edge of the waveform of the turn-off signal after the low-level voltage has been changed.

6. The light emitting device according to claim 5, wherein the undershoot circuit includes a coil element connected in series to the turn-off instructor, and a capacitive element connected between the coil element and a ground.

7. An exposing device comprising:
a light emitting device including:
a plurality of light emitting elements including anode terminals to which a reference potential is applied, and cathode terminals connected to a first end of a current limiting resistor in common;
a turn-on instructor configured to sequentially output turn-on instruction signals to the plurality of light emitting elements to sequentially turn ON the plurality of light emitting elements;
a turn-on potential applier configured to apply a turn-on potential to a second end of the current limiting resistor;
a turn-off instructor configured to, when turning OFF a light emitting element in an ON state, output a turn-off signal while changing the turn-off signal from a high level to a low level;
a level shift circuit configured to change a low-level voltage of the turn-off signal according to the turn-on potential; and
at least one turn-off thyristor including an anode terminal to which the reference potential is applied, a gate terminal connected to the first end of the current limiting resistor, and a cathode terminal to which the turn-off signal having the low-level voltage changed by the level shift circuit is input, the at least one turn-off thyristor being configured to be switched from OFF to ON when the turn-off signal reaches the low level, and change potentials at the cathode terminals of the plurality of light emitting elements to potentials at which the plurality of light emitting elements is turned OFF; and
a light exposure amount controller configured to control a light exposure amount of light exposure on an image carrier for formation of an electrostatic latent image by controlling a light intensity of light to be emitted from the light emitting device.

8. An image forming apparatus comprising:
an exposing device including:
a light emitting device including:
a plurality of light emitting elements including anode terminals to which a reference potential is applied, and cathode terminals connected to a first end of a current limiting resistor in common;
a turn-on instructor configured to sequentially output turn-on instruction signals to the plurality of light emitting elements to sequentially turn ON the plurality of light emitting elements;
a turn-on potential applier configured to apply a turn-on potential to a second end of the current limiting resistor;
a turn-off instructor configured to, when turning OFF a light emitting element in an ON state, output a turn-off signal while changing the turn-off signal from a high level to a low level;
a level shift circuit configured to change a low-level voltage of the turn-off signal according to the turn-on potential; and
at least one turn-off thyristor including an anode terminal to which the reference potential is applied, a gate terminal connected to the first end of the current limiting resistor, and a cathode terminal to which the turn-off signal having the low-level voltage changed by the level shift circuit is input, the at least one turn-off thyristor being configured to be switched from OFF to ON when the turn-off signal reaches the low level, and change potentials at the cathode terminals of the plurality of light emitting elements to potentials at which the plurality of light emitting elements is turned OFF; and
a light exposure amount controller configured to control a light exposure amount of light exposure on an image carrier for formation of an electrostatic latent image by controlling a light intensity of light to be emitted from the light emitting device;
a developing device configured to develop the electrostatic latent image on the image carrier that has been exposed to the light by the exposing device; and
a transferrer configured to transfer, onto a recording medium, an image on the image carrier that has been developed by the developing device.
